(19) United States
(12) Patent Application Publication
(10) Pub. No.: US 2024/0393049 A1
(43) Pub. Date: Nov. 28, 2024

(54) DRYING DEVICE FOR PROVIDING A PROCESS GAS FOR A DRYING SYSTEM

(71) Applicant: LÜBBERS ANLAGEN-UND UMWELTTECHNIK GMBH, Bad Langensalza (DE)

(72) Inventor: BERND FEUERRIEGEL, BERLIN (DE)

(73) Assignee: LÜBBERS ANLAGEN-UND UMWELTTECHNIK GMBH, Bad Langensalza (DE)

(21) Appl. No.: 18/691,077

(22) PCT Filed: Sep. 12, 2022
(86) PCT No.: PCT/DE2022/200214

§ 371 Date: Mar. 12, 2024

(30) Foreign Application Priority Data
Sep. 13, 2021 (DE) 10 2021 123 631.2

(51) Int. Cl. F26B 23/10; F26B 21/10; F26B 23/00

(52) U.S. Cl. CPC F26B 23/10; F26B 21/10; F26B 23/005

(57) ABSTRACT

A drying device for providing a process gas for a dryer plant. The drying device is associated with the dryer plant and with an external heat source. The drying device includes a heat pump unit for heating the process gas. The heat pump unit includes a heat pump with a circuit fluid, an evaporator, a compressor, a gas cooler, a throttle unit, and a superheater arranged between the evaporator and the compressor. Via a heat transfer fluid, the superheater is connectable and/or heatable via the external heat source arranged outside the heat pump unit and/or free of a direct heat transfer from a heat-emitting side of the heat pump unit, so that the circuit fluid is superheated after exiting the evaporator, the superheated circuit fluid is compressed via the compressor, and the compressed superheated circuit fluid is available to heat the process gas via the gas cooler.

### CROSS REFERENCE TO PRIOR APPLICATIONS

This application is a U.S. National Phase application under 35 U.S.C. § 371 of International Application No. PCT/DE2022/200214, filed on Sep. 12, 2022 and which claims benefit to German Patent Application No. 10 2021 123 631.2, filed on Sep. 13, 2021. The International Application was published in German on Mar. 16, 2023 as WO 2023/036386 A1 under PCT Article 21(2).

### FIELD

The present invention relates to a drying device for providing a process gas for a dryer plant, wherein the drying device comprises a heat pump unit for heating the process gas, and the dryer plant and at least one external heat source are associated with the drying device, wherein the heat pump unit has at least one heat pump with a circuit fluid, an evaporator, a compressor, a gas cooler, and a throttle unit.

### BACKGROUND

Heat pumps are used to provide a decentralized and energy-efficient energy supply, in particular with low CO₂ emissions and with the use of climate-neutral electricity. Smaller heat pumps with a heat output of a few hundred kilowatts are, for example, operated for decentralized residential heating and domestic hot water heating with a moderate local heat requirement at a low temperature level of less than 80° C., wherein a constant heat source, such as natural geothermal energy, is often used.

Industrial drying processes require large amounts of heat of several megawatts at high temperature levels of over 100° C. Such high temperatures are often generated by combustion processes using solid, liquid and/or gaseous carbon-based fuels with corresponding emissions of greenhouse gases. Specially designed high-temperature heat pumps are required to at least partially replace these combustion processes with heat pumps. For industrial processes, transcritically operated heat pumps with a heat output of the circuit fluid, for example, carbon dioxide, at supercritical pressure with a gas cooler as a heat transfer for temperature ranges up to 100° C. are usually used.

EP 2 321 589 B1 describes a transcritical high-temperature heat pump for heating a fluid to a temperature of up to 150° C. with carbon dioxide as the refrigerant in which the cold vapor from the evaporator is superheated before entering the compressor via at least one internal heat exchanger of the high-temperature heat pump. The heat of the transcritical cycle gas with a temperature level of over 40° C. is here transferred from the heat-emitting high-pressure side of the high-temperature heat pump of the gas cooler to the cold vapor exiting the evaporator of the low-pressure side via the internal heat exchanger. Due to this thermal connection between the heat-emitting, transcritical high-pressure side and the heat-absorbing, cold evaporator side via the internal heat exchanger, a regulation dependency exists between the heat output of the hot side and the overheating of the cold vapor of the cold side of the high-temperature heat pump which has a detrimental effect on the stability of the operation of the cycle process. Any process-related change and/or fluctuation in the rate at which useful heat is removed from the heat-emitting side here has a direct effect on the superheating of the cycle process gas before it is compressed. The direct heat transfer from the transcritical and heat-emitting high-pressure side to the cold low-pressure side within the high-temperature heat pump in particular results in a loss of useful heat capacity because part of the useful heat previously generated by compression is wasted directly by heat transfer to the cold vapor, whereby a proportion of about 15 to 20% of the total heat output is lost as useful heat.

EP 3 542 114 B1 describes a drying system with a drying unit and a heat pump assembly, wherein the heat pump assembly is connected to a heat pump in a fluid network with physically interconnected loops in which a secondary fluid circulates, via heat exchangers, with at least two heat sources and at least one heat sink. A heat exchanger upstream of the drying plant is here used to dehumidify the incoming process gas, and a second heat exchanger downstream of the drying plant is used for heat recovery from the exhaust gas of the drying plant, while a heat sink in a heat exchanger upstream of the drying plant is used to preheat the process gas after dehumidification. This means that the low-temperature waste heat from the process gas is supplied to the heat-absorbing evaporator side of the heat pump via the heat pump after it exits the drying plant, thus making the waste heat usable. The corresponding proportion of the waste heat is, however, absorbed at a low temperature level by the cold-generating side of the heat pump, as a result of which this proportion of the cold generation is lost for the generation of useful cold, which has a detrimental effect on the overall efficiency of the heat pump assembly.

It is also generally known to carry out heat recovery without using a heat pump via a heat exchanger in the exhaust gas stream of a dryer plant by transferring it to a heat exchanger for direct heating of the process gas prior to entering the dryer plant. The disadvantage here is that the waste heat of the exhaust gas in the form of moist exhaust air from the dryer plant with a high proportion of latent heat stored in the water vapor occurs at a low temperature level and the proportion of sensible heat that can be recovered due to the higher temperature is only less than a third of the total heat content of the exhaust gas. The greater proportion of the heat content of the exhaust gas can additionally only be recovered at a very low temperature level of just below the ambient temperature.

### SUMMARY

An aspect of the present invention is to improve upon the prior art.

In an embodiment, the present invention provides a drying device for providing a process gas for a dryer plant. The drying device is associated with the dryer plant and with at least one external heat source. The drying device includes a heat pump unit for heating the process gas. The heat pump unit comprises at least one heat pump which comprises a circuit fluid, an evaporator, a compressor, a gas cooler, a throttle unit, and a superheater which is arranged between the evaporator and the compressor. The superheater is, via at least one heat transfer fluid, connectable and/or heatable via the at least one external heat source which is/are spatially arranged outside the heat pump unit and/or free of a direct heat transfer from a heat-emitting side of the heat pump unit, so that the circuit fluid is superheated via the superheater after exiting the evaporator so as to obtain a superheated circuit fluid, the superheated circuit fluid is compressed via the compressor so as to obtain a compressed superheated circuit fluid, and the compressed superheated circuit fluid is available to heat the process gas via the gas cooler.

### BRIEF DESCRIPTION OF THE DRAWINGS

The present invention is described in greater detail below on the basis of embodiments and of the drawings in which:

FIG. 1 shows a schematic representation (flow chart) of a drying system according to the present invention with a heat pump unit and an exhaust gas heat exchanger for heat recovery from the exhaust gas of a dryer plant as an external heat source for heating a superheater of the heat pump unit;

FIG. 2 shows a schematic representation of an alternative of the drying system according to the present invention with a waste heat flux from a process gas heater as an external heat source for heating the superheater;

FIG. 3 shows a T-s diagram from the operation of a heat pump of the heat pump unit of the drying system shown in FIG. 1;

FIG. 4 shows a further alternative of the drying system with another external heat source for heating the superheater of the heat pump unit and a supply of heated cooling water to an evaporator of the heat pump unit for providing useful cold; and

FIG. 5 shows another alternative of the drying system according to the present invention with the combined use of multiple external heat sources.

### DETAILED DESCRIPTION

The present invention provides a drying device for providing a process gas for a dryer plant, wherein the drying device comprises a heat pump unit for heating the process gas and the dryer plant and at least one external heat source are associated to the drying device, wherein the heat pump unit comprises at least one heat pump with a circuit fluid, an evaporator, a compressor, a gas cooler, and a throttle unit, and the heat pump comprises a superheater between the evaporator and the compressor, wherein the superheater is connectable and/or heatable via at least one heat transfer fluid to the at least one associated external heat source spatially arranged outside the heat pump unit and/or free from direct heat transfer from a heat-emitting side of the heat pump unit, so that the circuit fluid can be superheated via the superheater after exiting the evaporator, the superheated circuit fluid can then be compressed via the compressor and can be used to heat the process gas via the gas cooler.

A drying device is thereby provided in which at least one heat pump having a superheater between the evaporator and compressor is used to superheat the heat transfer fluid in the superheater via an external heat source and consequently an externally supplied heat flow, thereby allowing for a heat recovery at high outputs of several hundred kilowatts or several megawatts at a very low temperature level of in particular a maximum of 45° C., for example, less than 40° C. The fully externally heated superheater of the heat pump with simultaneous heat recovery of external low-temperature heat advantageously provides energy and control and/or regulation independence during operation of the heat pump unit and the drying device.

The external heating enables a precise temperature control of the superheater upstream of the compressor and thus precisely meets the specified operating points of the compressor, thereby preventing damage to the compressor and provides the efficiency of the compressor. Impermissibly high and/or low temperatures upstream of the compressor inlet are consequently avoided, wherein otherwise excessively high impermissible temperatures would lead to a decreasing density of the circuit fluid, a reduced volumetric performance of the compression, and thus to a loss of efficiency of the compressor. By avoiding temperatures that are too low before entering the compressor, an increase in the power consumption of the compressor to reach the desired final temperature after compression or, if the power consumption remains constant, a drop in the temperature reached by compression, is avoided, which would otherwise cause the heat-emitting side of the heat pump to lose significant power for heating the process gas. The external heating of the superheater therefore always provides an optimum inlet temperature before entering the compressor and provides an optimum overall efficiency of the heat pump.

The drying device therefore comprises a heat pump with a high economic efficiency which is significantly higher than the efficiency of known heat pumps, as both the heat output on the high-pressure side of the heat pump can be used as useful heat as fully as possible and its heat absorption in the evaporator on the low-pressure side can be used as fully as possible as useful cold. High energy efficiency and cost-effectiveness of the drying device is consequently made possible by a coupled generation of useful heat and/or useful cold with the lowest possible CO₂ emissions, taking into account the specific emission factors of the respective types of energy used.

A core idea of the present invention is based on heating a superheater integrated in a heat pump and/or heat pump unit separately via an external heat source and precisely not to carry out the heating directly via a medium which was previously heated by the heat-emitting side of the heat pump unit. The superheater for heating is thus free from a direct connection and/or a direct heat transfer from a heat-emitting side of the heat pump unit and/or the heat pump. The fact that the heater is supplied with heat for heating via at least one heat transfer fluid from the at least one associated suitable external heat source provides that the superheater is optimally stable and can be operated independently of the remaining operating states of the circuit fluid of the heat pump and/or the operating states of the drying device.

The following terminology is explained:

A “drying device” is in particular a device for providing a process gas for a drying plant. The drying device in particular comprises at least one heat pump unit with at least one heat pump. The drying device is in particular associated to the dryer plant and at least one external heat source, or the drying device comprises this dryer plant and the at least one external heat source. The drying device can thus also be a drying system having multiple devices, means, facilities, apparatus and/or components.

A “process gas” is in particular a gas that is supplied to a dryer plant. The process gas is in particular dehumidified, preheated and/or heated upstream of the dryer plant. In the dryer plant, the process gas in particular serves for drying a material to be dried, for example, a hygroscopic powder. The process gas can in particular be air.

A “dryer plant” is in particular a device for drying a material to be dried via the heated process gas. A dryer plant can, for example, be a drying tower and/or a spray dryer. The dryer plant is in particular used for drying solutions, suspensions and/or emulsions.

A “heat pump unit” is in particular a unit that has at least one heat pump or multiple heat pumps. The heat pump unit can also comprise a control and/or regulating unit.

A “heat pump” is, in particular, a machine that uses technical work to absorb thermal energy from a reservoir and/or a heat source at a low temperature and, together with drive energy, transfers it as useful heat to a system to be heated at a higher temperature. A heat pump is in particular a transcritically-operated heat pump and/or a high-temperature heat pump. The heat pump in particular has an evaporator as the heat-absorbing side, followed by a superheater for superheating the circuit fluid, a downstream compressor, a gas cooler for heat dissipation to heat the process gas, and a throttle unit in a circuit connection of the circuit fluid.

A “circuit fluid” is in particular a fluid that is guided within the heat pump as a heat transfer medium. A circuit fluid is in particular a refrigerant such as carbon dioxide. The circuit fluid and/or the carbon dioxide is in particular operated above the critical point so that a transcritical circuit fluid is present. The critical point for carbon dioxide is in particular approximately +31° C. and 74 bar. Due to the transcritical operation, the heat pump therefore does not have a condenser (liquefier), but a gas cooler.

An “evaporator” is in particular an apparatus and an integral part of the heat pump and converts the circuit fluid into its vaporous state. The evaporator is in particular a heat exchanger at which heat from an external heat source is transferred to the circuit fluid, wherein the circuit fluid evaporates, especially at low pressure. The external heat source releases energy during the process, which is why the temperature of its heat transfer fluid decreases. The heat transfer fluid of the external heat source can flow directly through the evaporator or the heat of the heat transfer fluid is transferred to the evaporator via a heat exchanger of the external heat source.

A “superheater” is in particular an apparatus of the heat pump that heats the vaporous circuit fluid downstream of the evaporator beyond its evaporation temperature. The superheater in particular transfers the circuit fluid into a superheated state.

A compressor is in particular an apparatus of the heat pump that increases the pressure and density of the heated, transcritical circuit fluid, and thus compresses it. The compressor in particular performs mechanical work on the enclosed, transcritical circuit fluid, which is why the circuit fluid heats up during compression.

A “gas cooler” is in particular a heat exchanger that transfers the heat of the hot compressed circuit fluid to the outside of the heat pump unit and/or the heat pump. The heat emitted by the gas cooler is in particular used to heat the process gas for the dryer plant. The gas cooler as a heat exchanger can in particular also transfer the heat directly to the process gas. As the gas volumetric flow rate of the process gas in industrial dryer plants is considerably higher than the volumetric flow rate of the circuit fluid in the heat pump, it is more advantageous to fluidically connect the heat-emitting side of the gas cooler to a heat exchanger in the process gas flow. The cooling of the circuit fluid compressed to supercritical conditions by the gas cooler thus represents the heat output of the heat pump. The heat output on the heat-emitting high-pressure side is here transferred via the gas cooler, in particular not on a fixed temperature plateau, but over a sometimes wide temperature range, which can reach up to the ambient temperature.

It is particularly advantageous, for example, if a transcritically operated heat pump comprises multiple gas coolers, as the temperature differences in the individual gas coolers can be better adapted to the temperature profile of the circuit fluid, which exhibits large changes in its specific heat capacity during transcritical cooling, by distributing the heat to be dissipated from the heat-emitting side to multiple gas coolers.

A transcritically operated heat pump so configured is particularly advantageous for industrial drying processes in which the process gas must often be heated from an ambient temperature to temperatures in the range of over 100° C. to over 200° C. which are required for the drying process.

An “external heat source” is in particular a source that emits heat and is spatially arranged outside the heat pump unit and the heat pump and/or whose heat transfer medium originates spatially from outside the heat pump unit and/or the heat pump. The external heat source is in particular free from direct heat transfer from a heat-emitting side of the heat pump unit to the superheater. This means that the external heat source is not the directly emitted heat of the gas cooler or that this heat is used directly to heat the superheater. The heat source can, for example, be designed directly as a heat transfer medium, for example, the external heat source is a heated cooling water or a heated exhaust gas stream. The external heat source can, for example, have a maximum temperature of 45° C.

In a further embodiment of the drying device, the heat pump unit comprises a second heat pump, a third heat pump, and/or further heat pumps.

As a result, the heat output and/or the amount of heat to be dissipated can be optimally adapted to the requirements for heating the process gas before it enters a dryer plant. By integrating multiple high-temperature heat pumps in a heat pump unit and in an associated drying process, a total heat output of around 4 MW can, for example, be provided for heating the process gas.

A “second, third and/or further heat pump” can, for example, be a heat pump as defined above in terms of design and function, wherein a combination of heat pumps of different designs and functions is also considered.

In order to provide a drying system and/or to integrate the dryer plant and/or the at least one external heat source in terms of system technology, the drying device has the dryer plant and/or the at least one external heat source.

In a further embodiment of the drying device, the superheater is connectable via a respective heat transfer fluid to a second associated external heat source, a third associated external heat source, and/or further associated external heat sources, each spatially arranged outside the heat pump unit, and/or the drying device comprises a second external heat source, a third external heat source, and/or further external heat sources, in each case outside the heat pump unit.

Any combination of multiple external heat sources can thus be used to heat the superheater, wherein their different heat outputs and temperature levels are combined, for example, by appropriate regulation of flow rates and mixing points, for optimum heating of the superheater.

A respective external heat source is advantageously used which both provides sufficient heat at a suitable temperature in order to supply the superheater with sufficient heat in all relevant operating states and which at the same time has low fluctuations in the temperature level in order to avoid or minimize disturbances of the continuous superheating in the superheater. The temperature level of the respective external heat source can, for example, only be a few Kelvin above the superheating temperature of the circuit fluid to be reached in the superheater so that excessive temperature differences between the respective heat source and the heat transfer fluid and between the heat transfer fluid and the superheated circuit fluid at the transition between the superheater and compressor are avoided.

In order to utilize a waste heat flux from the dryer plant with a high throughput rate and at the same time a relatively low temperature, for example, a maximum of 45° C., the at least one external heat source or one of the external heat sources is designed as a heat exchanger downstream of the dryer plant for heat recovery from an exhaust gas of the dryer plant so that heat from the exhaust gas can be transferred via the heat exchanger to the heat transfer fluid for heating the superheater.

At this relatively low temperature level of the external heat source, an economically viable superheating of the cold vapor in the superheater before compression can amount to around 15 to 20% of the total heat output, which is transferred via the transcritical gas cooler or the transcritical gas coolers on the heat-emitting side after compression. Due to the use of the external heat source, part of the useful heat previously generated by compression is thus not wasted directly by heat transfer to the cold vapor within the heat pump circuit and thus not the proportion of about 15 to 20% of the total heat output.

By using the exhaust gas from the dryer plant via an exhaust gas heat exchanger to recover heat and heat the superheater, the process gas can be heated to a temperature level of over 100° C. via the heat-emitting side of the heat pump unit via a process gas heat exchanger, for example, to over 120° C., which corresponds to approximately 50 to 60% of the heat output required to heat the process gas from an ambient temperature before entering the dryer plant to the temperature of approximately 200° C. required for the drying process.

A “heat exchanger” is a device that transfers thermal energy from one material flow to another material flow. A heat exchanger is in particular an indirect heat exchanger in which the two material flows are spatially separated by a heat-permeable wall. One of the mass flows flowing through the heat exchanger may, for example, be the heat transfer fluid in a circuit with the superheater or another heat transfer medium which is connected in a circuit with another heat exchanger and/or gas cooler.

In a further embodiment of the drying device, the at least one external heat source or one of the external heat sources is a heater for heating the process gas prior to entering the dryer plant so that heat from a waste heat flux from the heater can be transferred to the heat transfer fluid for heating the superheater via a downstream heat exchanger.

When the process gas is heated to higher temperatures, for example, 200° C., before entering the dryer plant via the heater, the waste heat generated can be used to heat the superheater. The exhaust gas and/or waste heat flux exiting the heater of the process gas sometimes has a similarly high water vapor content as the exhaust gas from the dryer plant. This means that in addition to the exhaust gas stream from the dryer plant, the waste heat flux from the heater provides a second external heat source.

In order to achieve the required temperature of the process gas prior to entering the dryer plant, depending on the drying process, and to provide a sufficient external heat source for heating the superheater, the heater for heating the process gas is configured as an indirect gas burner, an indirect steam heater, and/or a gas turbine that can be operated with a fuel.

In the case of the indirect gas burner, the heat of the exhaust gas exiting the indirect gas burner can thus be used as an external usable heat source for heat transfer and heating the superheater. In the case of a gas turbine, the combustion of a gaseous and/or liquid fuel similarly produces an exhaust gas that can be used to heat the superheater. In the case of an indirect steam heater, the waste heat flux is used accordingly, wherein, in this case, the condensate flow from the steam heater represents a possible external heat source for heating the superheater. Due to the significantly higher temperature level of the condensate compared to the permissible temperature of the superheater, it can in this case be advantageous to first transfer a proportion of the condensate heat with a high temperature level to another heat sink via a pre-cooler, and to subsequently heat the superheater with the remaining heat.

In a further embodiment of the drying device, a pre-cooler for transferring heat from the waste heat flux to a heat transfer medium on the heat-emitting side of the heat pump unit and subsequently a heat exchanger for transferring residual heat from the waste heat flux downstream of the pre-cooler to the superheater via the heat transfer fluid are connected downstream of the heater.

The gas cooler on the heat-emitting high-pressure side of the heat pump can thereby be supported by the heat transfer via the pre-cooler. The subsequent heat transfer of the residual heat after the pre-cooler to the heat transfer fluid for heating the superheater prevents impermissibly high temperatures of the circuit fluid in the superheater. The waste heat flux from the exhaust gas or condensate exiting the heater can be used for this purpose depending on the type of heater.

For efficient heat transfer, condensate from the pre-cooler is directly used as the heat transfer fluid for heating the superheater.

The pre-cooled condensate from the indirect steam heater can thus be used directly to heat the superheater by passing the condensate directly through the superheater for heating instead of the circuit fluid. The flow of pre-cooled condensate is in this case adapted to the heat requirement for heating the superheater so that the superheater is neither overheated nor underheated.

In a further embodiment, the drying device and/or the heat pump unit comprises a control and/or regulating unit so that a temperature and/or a volumetric flow rate of the respective heat transfer fluid for heating the superheater can be controlled and/or regulated via of the control and/or regulating unit.

This provides an optimum combination and use of multiple external heat sources via the control and/or regulating unit of the drying device and/or the heat pump unit while sufficiently heating the superheater and maintaining the specified temperature level.

The temperature and the flow rate of the respective heat transfer fluid, which flows through the superheater for heating, can, for example, be regulated via a control and/or regulating unit of the drying device so that the temperature of the circuit fluid, which is continuously superheated in the superheater in the superheating area, is maintained at an adjustable target value before entering the compressor in order to thereby avoid both excessively high and excessively low superheating temperatures of the circuit fluid at the outlet from the superheater in all operating states and to keep the subsequent compression of the superheated circuit fluid in the compressor at the optimum operating point in order to optimize the efficiency of the heat pump, wherein the operating point can, for example, be determined and specified by a further control and/or regulating unit of the heat pump unit.

The term “control device” in particular refers to a device that sets a predefined value. A “regulating device” is in particular understood to be a device that feeds back a measured value and sets a control value in each case. The control and/or regulating unit can thus be used to set and/or regulate the optimum-efficient operating point of the heat pump and an optimal heat transfer of the heat pump and/or the other components of the drying device.

In order to avoid and/or remove an accumulation of fine dust and/or condensate in the heat exchanger of the waste heat flux and/or exhaust gas, the heat exchanger for heat recovery from the exhaust gas of the dryer plant comprises at least one connection for carrying out cleaning, in particular using the clean-in-place process, and/or a demister in the outlet of the exhaust gas.

Cleaning on site using the clean-in-place process means that the heat exchanger can be put back into operation immediately after cleaning.

Particularly when drying liquids and/or suspensions containing particles to produce a powdery product, such as milk powder, an increased proportion of fine dust is to be expected in the exhaust gas and/or condensate which can accumulate in the exhaust gas heat exchanger. The fact that the heat exchanger has suitable connections and therefore a cleaning option for wet cleaning using the clean-in-place process (CIP) means that the heat transfer surfaces on the exhaust gas side can be kept free of possible deposits, for example, of chemical or microbiological origin.

Condensate droplets can also contain dissolved or suspended fine powder particles and/or microbiological contamination so that these loaded condensate droplets are removed from the exhaust air heat exchanger by the demister at the outlet of the exhaust gas in order to prevent discharge.

The “clean-in-place process” in particular refers to localized cleaning of the heat exchanger without it having to be substantially dismantled. For the clean-in-place process, the heat exchanger has appropriate connections through which it can be flushed and/or thermally treated.

A “demister” (also known as an “aerosol separator”) is, in particular, an apparatus for separating liquid droplets from a flowing gaseous medium and/or process gas. The demister is in particular used to separate condensate droplets from the exhaust gas downstream of the dryer plant.

In a further embodiment, a heated cooling medium can flow directly through the evaporator as the heat-absorbing side of the heat pump as an external heat source, in particular after a dehumidification of a supply air and/or the process gas.

The coupled generation of useful heat and useful cold makes the heat pump particularly energy-efficient, as the use of a heat source (heated cooling medium) at a low temperature level via the cold, heat-absorbing side of the heat pump is not only used for the physical operation of the heat pump cycle process, but at the same time constitutes an advantage for other processes with cooling requirements. The heated cooling water as an external heat source in particular has a temperature of less than 20° C. in the feed flow to the evaporator and a temperature of less than 4° C. in the return flow from the evaporator so that the return flow is used to provide useful cold for another process. Useful cold is generally understood to be heat absorption at a temperature level significantly below room temperature if this serves an industrial and/or economically required cooling process and thus the heated coolant from another process is cooled down again for further use in the other process by means of a heat exchanger and/or directly by the evaporator. The heated coolant can advantageously flow directly through the evaporator, or a heat exchanger is interposed between coolant and evaporator.

The present invention also provides a method for providing a process gas for a dryer plant via a drying device described above, the method comprising the following steps:
Operating at least one heat pump with a circuit fluid;
Heating the superheater of the heat pump via an external heat source spatially arranged outside the heat pump unit of the drying device and/or free from direct heat transfer from a heat-emitting side of the heat pump unit so that a superheated circuit fluid is present; and
Compressing the superheated circuit fluid in the compressor of the heat pump and heat transfer of the heat of the compressed, superheated circuit fluid via the gas cooler of the heat pump for heating the process gas.

The present invention is described in greater detail below under reference to exemplary embodiments as shown in the drawings.

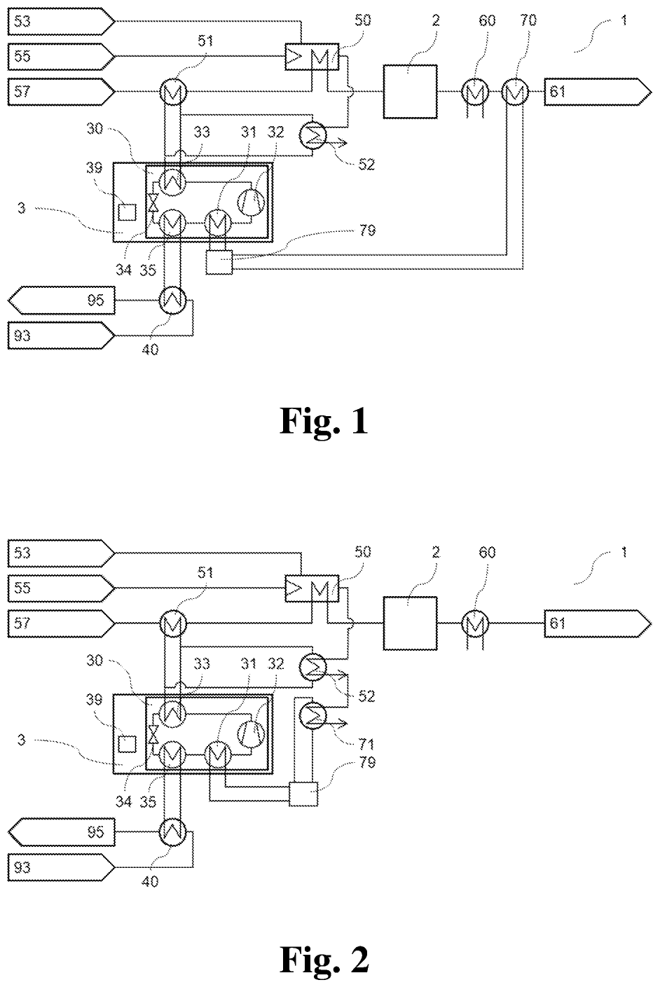

A drying system 1 shown in FIG. 1 has a dryer plant 2 and a heat pump unit 3 with a heat pump 30. The heat pump unit 3 also has a first control and regulating unit 39. The heat pump 30 has a circuit with a circuit fluid, an evaporator 35 as the heat-absorbing side of the heat pump 30, a superheater 31, a compressor 32, and a gas cooler 33 as the heat-emitting side of the heat pump 30, as well as a downstream throttle unit 34. To heat a process gas 57, the gas cooler 33 is fluidically connected to a process gas heat exchanger 51. To heat a process gas 57, the process gas 57 is first supplied to the process gas heat exchanger 51 and, subsequently, the thereby preheated process gas 57 is then supplied to a process gas heater 50 in which the process gas 57 is further heated to a required temperature of approximately 200° C. through addition of combustion air 53 and fuel 55 before the fully heated process gas 57 is supplied to the dryer plant 2.

An exhaust gas 61 exiting the dryer plant 2 is cooled via a first exhaust gas heat exchanger 60 with pure convection and fed to a subsequent exhaust gas heat exchanger 70 with a low temperature level for heating the superheater 31. The exhaust gas 61 exits the drying system 1 into an environment at the outlet of the exhaust gas heat exchanger 70.

The waste heat is transferred from the exhaust gas heat exchanger 70 to the superheater 31 via a heat transfer fluid, wherein the superheater 31 is connected to a second control and regulating unit 79. The exhaust gas heat exchanger 70 is arranged spatially outside the heat pump unit 3 and does not directly transfer heat on the heat-emitting side to the superheater 31 via the gas cooler 33 of the heat pump 30. The exhaust gas heat exchanger 70 therefore represents an external heat source. A second external heat source is supplied to the evaporator 35 in the form of a feed flow of heated cooling water 93 via a heat exchanger 40 and exits the drying system 1 as a return flow of cooled cooling water 95 as usable useful cold that can be used in another process.

During operation of the heat pump 30 shown in FIG. 1, carbon dioxide is vaporized as a circuit fluid via a heat transfer from the feed flow of heated cooling water 93 via the heat exchanger 40 via the evaporator 35 and then superheated by the superheater 31 heated by the external heat source of the exhaust gas heat exchanger 70. The superheated carbon dioxide is then compressed in the compressor 32 and thereby heated. The heat of the carbon dioxide is subsequently transferred in the gas cooler 33 to the heat transfer medium fluidically connected to the process gas heat exchanger 51 and thus exits the heat pump unit 3. The process gas 57 is preheated by the process gas heat exchanger 51 and then, as described above, further heated to the required temperature for the drying process in the dryer plant 2 by the process gas heater 50.

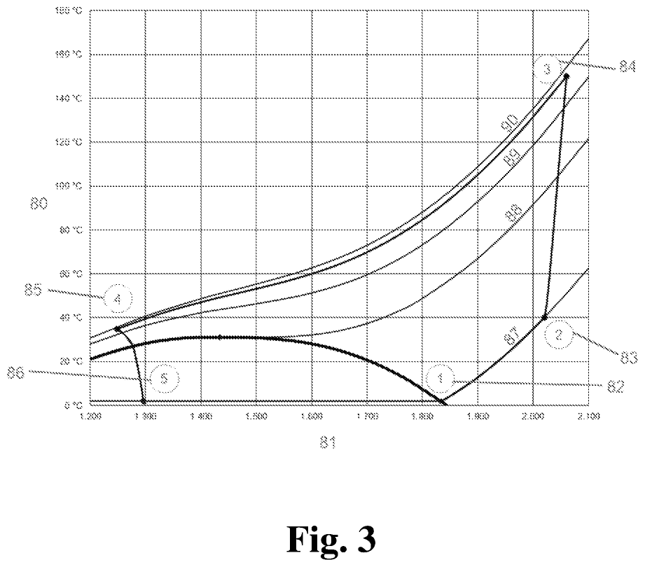

FIG. 3 shows the T-s diagram associated with the drying system 1 with the temperature T (80) in ° C. and the specific entropy s (81) in J/kgK, wherein a first isobar 87 with a pressure of 36.7 bar, a second isobar 88 with a pressure of 73.7 bar, a third isobar 89 with a pressure of 100.00 bar, and a fourth isobar 90 with a pressure of 120.00 bar are plotted. The carbon dioxide gas is shown at state point 1 (82) which exits the evaporator 35 of the heat pump unit 3 as cold vapor after evaporation of the liquid component from state point 5 (86). In the superheater 31, the cold vapor of the carbon dioxide gas is heated from state point 1 (82) to state point 2 (83) to a temperature that is stably regulated by the second control and regulating unit 79 at a pressure level that is as constant as possible, wherein the state of the carbon dioxide changes from the saturated cold vapor of state point 1 (82) to the superheated vapor of state point 2 at a temperature of just under 40° C. along the first isobar 87 at a pressure of 36.7 bar. After superheating in the superheater 31, the carbon dioxide enters the compressor 32 as a circuit fluid at state point 2 (83) and then exits the compressor 32 at state point 3 (84) at a temperature of approximately 150° C. The subsequent heat output in the gas cooler 33 from the state point 3 (84) to the state point 4 (85) parallel to the fourth isobar 90 corresponds to the heat output of the heat pump 30 on its heat-emitting high-pressure side via the gas cooler 33.

From the state point 4 (85), the high pressure of the carbon dioxide is expanded via a throttle unit 34, which can be adjusted via the first control and regulating unit 39 of the heat pump unit 3, to the state point 5 (86) at approximately isenthalp in the wet vapor range. The carbon dioxide therefore cools down very quickly as a circuit fluid and part of the circuit fluid forms liquid condensate. The portion of the condensate that forms is separated from the remaining wet vapor in a condensate collector not shown in FIG. 1 and is almost completely evaporated in the evaporator 35 from the state point 5 (86) to the state point 1 (82), which corresponds to a cooling capacity of the evaporator 35 of the heat-absorbing side of the heat pump 30. The wet vapor remaining downstream the throttle unit 34 from the state point 4 (85) to the state point 5 (86) exits the condensate collector (not shown) as saturated wet vapor and is combined with the saturated wet vapor from the evaporator 35 to form the cold vapor of the state point 1 (82). This cycle process runs continuously in the heat pump 30 during its operation.

By using the exhaust gas heat exchanger 70 as an external heat source to heat the superheater 31, a heated process gas 57 with a temperature of approximately 120° C. can be obtained downstream of the process gas heat exchanger 51. The preheated process gas 57 is then fed into the process heater for further heating to the temperature of 200° C. required for the drying process. A waste heat flux from the process gas heater 50 can be used via a pre-cooler 52 to support the heat-emitting side of the heat pump 30 and thus the gas cooler 33.

A high heat transfer capacity in the range of 30 to 40° C. can therefore be achieved from the exhaust gas heat exchanger 70 for the heat transfer from the condensed exhaust gas to the heat transfer fluid and thus from the carbon dioxide as circuit fluid in the superheater 31, wherein even a slight cooling of the exhaust gas in the exhaust gas heat exchanger 70 by only 10° C. provides a high intrinsic safety against excessively high temperatures in the superheater 31. Via the drying system 1, the exhaust gas heat exchanger 70 and the heat pump unit 30, condensation heat in the temperature range between 30° C. and 40° C. can be transferred from the condensing exhaust gas in the exhaust gas heat exchanger 70 to the heat transfer medium and thus recovered as heat output and used to superheat the superheater 31. This therefore corresponds to more than half of the waste heat that would otherwise be lost with the exhaust gas 61 because the temperature is too low.

In an alternative drying system 1 shown in FIG. 2, an exhaust gas heat exchanger 70 for heating the superheater 31 is omitted. The drying system 1 instead also has a heat exchanger 71 downstream the pre-cooler 52 to heat the superheater 31. The flow diagram shown in FIG. 2 otherwise corresponds to the structure described in FIG. 1. After preheating via the process gas heat exchanger 51, as described above, the process gas 57 is heated to 200° C. by the process gas heater 50. The process gas heater 50 thus represents an external heat source for heat transfer to the superheater 31. The waste heat flux from the process gas heater 50 sometimes has a similarly high water vapor content as the exhaust gas from the drying plant shown in FIG. 1. The waste heat flux from the process gas heater 50 is first transferred in a pre-cooler 52 with part of its heat content at a higher temperature level to a heat transfer medium to support the performance of the gas cooler 33 on the heat-emitting side of the heat pump unit 3 and then part of its residual heat is used by the heat exchanger 71 to heat the superheater 31 to its permitted temperature level. Operation of the heat pump 30 otherwise takes place as described above.

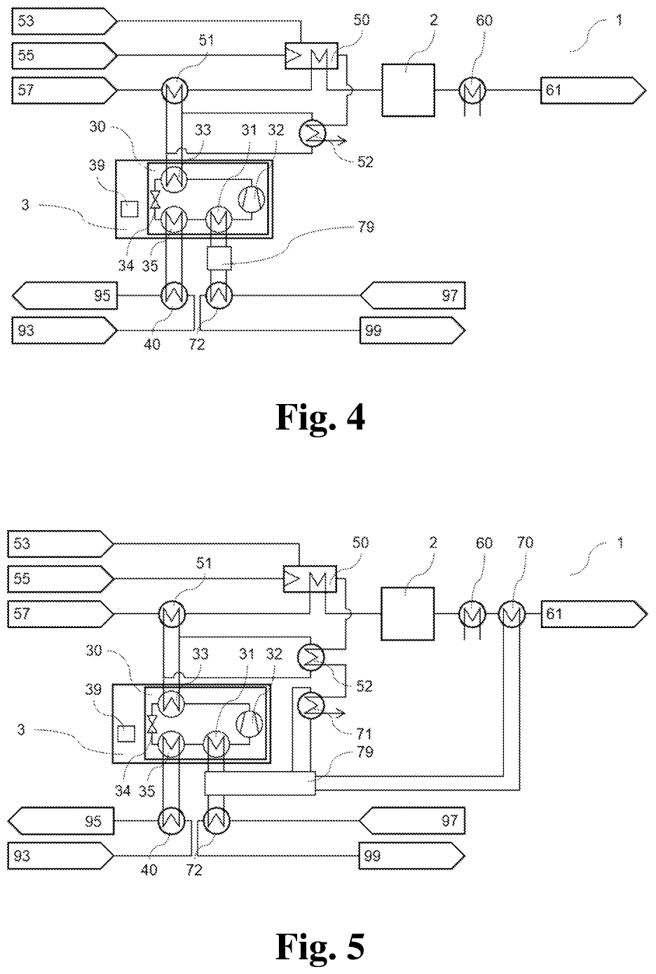

A further alternative of the drying system 1 is shown in FIG. 4 which, compared to the alternative drying system 1 shown in FIG. 2, does not have a heat exchanger 71 for superheater heating, which is thermally connected to the process gas heater 50, but a further external heat source is connected to a feed line 97 and a return line 99 via a heat exchanger 72 for heating the superheater 31. This further external heat source can, for example, be the heat of an auxiliary unit that is located in close proximity to the dryer plant 2. The heat from the further external heat source is in this case heated via the feed line 97 in the heat exchanger 72 to a heat transfer fluid to a temperature level permitted for the superheater 31 by the first control and regulating unit 39, and this heat transfer fluid is regulated via the second control and regulating unit 79 in order to heat the superheater 31. The heat pump unit 3 with the heat pump 30 and the drying system 1 are otherwise operated as described above.

A further alternative of the drying system 1 is shown in FIG. 5 where three different external heat sources are used to heat the superheater. These are the exhaust gas heat exchanger 70 already described above and the heat exchanger 71 already described above, which is thermally connected to the process gas heater 50. The third external heat source is the further external heat source already described in FIG. 4 with the feed line 97 and the return line 99 to and from the heat exchanger 72 for heating the superheater 31. The external heat sources and heat exchangers 70, 71 and 72, each with their different heat outputs and temperature levels, are here optimally combined in their flow rates and mixing points via regulation by the second control and regulating unit 79 in order to provide sufficient heating of the superheater 31 at a temperature level specified by the first control and regulating unit 39.

An efficient heat transfer for heating the process gas 57 for the dryer plant 2 is thus achieved by a superheater 31 integrated in the heat pump 30 between the evaporator 35 and the compressor 32 with a heat transfer for heating the superheater 31 via an external heat source or multiple external heat sources arranged outside the heat pump unit 3.

The present invention is not limited to embodiments described herein; reference should be had to the appended claims.

### LIST OF REFERENCE NUMERALS

1 Drying system
2 Dryer plant
3 Heat pump unit
30 Heat pump
31 Superheater
32 Compressor
33 Gas cooler (of the heat-emitting side)
34 Throttle unit
35 Evaporator (of the heat-absorbing side)
39 First control and regulating unit
40 Heat exchanger
50 Process gas heaters
51 Process gas heat exchanger (of the heat sink)
52 Pre-cooler
53 Combustion air
55 Fuel
57 Process gas
60 Exhaust gas heat exchanger (for heat recovery)
61 Exhaust gas
70 Exhaust gas heat exchanger (for superheater heating)
71 Heat exchanger (for superheater heating)
72 Heat exchanger (for superheater heating)
79 Second control and regulating unit
80 Temperature T (in ° C.)
81 Specific entropy s (in J/kgK)
82 State point 1
83 State point 2
84 State point 3
85 State point 4
86 State point 5
87 First isobar
88 Second isobar
89 Third isobar
90 Fourth isobar
93 Feed flow of heated cooling water
95 Return flow of cooled cooling water
97 Feed line (of additional external heat source)
99 Return line (of additional external heat source)

What is claimed is:

1-12: (canceled)

13: A drying device for providing a process gas for a dryer plant, the drying device being associated with the dryer plant and with at least one external heat source, the drying device comprising:
a heat pump unit for heating the process gas, the heat pump unit comprising at least one heat pump which comprises a circuit fluid, an evaporator, a compressor, a gas cooler, a throttle unit, and a superheater which is arranged between the evaporator and the compressor,
wherein,
the superheater is, via at least one heat transfer fluid, connectable and/or heatable via the at least one external heat source which is/are spatially arranged outside the heat pump unit and/or free of a direct heat transfer from a heat-emitting side of the heat pump unit, so that,
the circuit fluid is superheated via the superheater after exiting the evaporator so as to obtain a superheated circuit fluid,
the superheated circuit fluid is compressed via the compressor so as to obtain a compressed superheated circuit fluid, and
the compressed superheated circuit fluid is available to heat the process gas via the gas cooler.

14: The drying device as recited in claim 13, wherein the heat pump unit further comprises at least one of a second heat pump, a third heat pump, and additional heat pumps.

15: The drying device as recited in claim 13, further comprising:
at least one of the dryer plant and the at least one external heat source.

16: The drying device as recited in claim 13, wherein,
the superheater is connectable via a respective one of the at least one heat transfer fluid to at least one of a second associated external heat source, a third associated external heat source, and further associated external heat sources, each of which is spatially arranged outside the heat pump unit, and/or
the drying device comprises at least one of a second external heat source, a third external heat source, and further external heat sources, each of which is outside the heat pump unit.

17: The drying device as recited in claim 13, further comprising:
a downstream heat exchanger,
wherein,
at least one of the at least one external heat source is a heater which heats the process gas prior to the process gas entering the dryer plant so that heat from a waste heat flux of the heater is transferred to the at least one heat transfer fluid for heating the superheater via the downstream heat exchanger.

18: The drying device as recited in claim 17, wherein the heater for heating the process gas is at least one of an indirect gas burner, an indirect steam heater, and a gas turbine which is operated with a fuel.

19: The drying device as recited in claim 18, wherein the heater comprises a downstream-connected pre-cooler for transferring the heat from the waste heat flux to a heat transfer medium of the heat-emitting side of the heat pump unit and then to the downstream heat exchanger so as to transfer a residual heat of the waste heat flux downstream of the pre-cooler via the heat transfer fluid to the superheater.

20: The drying device as recited in claim 19, wherein a condensate of the downstream-connected pre-cooler is directly the at least one heat transfer fluid for heating the superheater.

21: The drying device as recited in claim 13, wherein,
at least one of the drying device and the heat pump unit of the drying device further comprises a control and/or regulating unit, and
the control and/or regulating unit is configured to at least one of control and regulate at least one of a temperature and a volumetric flow rate of the respective at least one heat transfer fluid for heating the superheater.

22: The drying device as recited in claim 13, wherein at least one of the at least one external heat source is a heat exchanger which is arranged downstream of the dryer plant to provide a heat recovery from an exhaust gas of the dryer plant so that heat from the exhaust gas is transferred via the heat exchanger to the at least one heat transfer fluid for heating the superheater.

23: The drying device as recited in claim 22, wherein the heat exchanger for the heat recovery from the exhaust gas of the dryer plant comprises at least one of at least one connection for carrying out a cleaning and a demister in an outlet of the exhaust gas.

24: The drying device as recited in claim 23, wherein the cleaning is a clean-in-place process.

25: The drying device as recited in claim 22, wherein,
the evaporator is a heat-absorbing side of the heat pump unit, and
the evaporator is flowed through directly with a heated cooling medium as an external heat source.
